(19) United States
(12) Patent Application Publication
(10) Pub. No.: US 2019/0081945 A1
(43) Pub. Date: Mar. 14, 2019

(54) Portable Device with Thermal Sensor

(71) Applicant: Zeppelin Corporation, Apia (WS)

(72) Inventors: Kuo-Ching CHIANG, New Taipei (TW); Yi-Chuan Cheng, Changhua County (TW)

(21) Appl. No.: 16/128,800

(22) Filed: Sep. 12, 2018

(30) Foreign Application Priority Data
Sep. 13, 2017 (TW) 106131466

(51) Int. Cl. H04L 29/06; H04N 5/247; H04N 5/265; H04N 5/232; G06K 9/20; H04M 1/02

(52) U.S. Cl. CPC H04L 63/0861; H04N 5/247; H04N 5/265; G06K 9/00221; G06K 9/209; H04M 1/0202; H04N 5/23245

(57) ABSTRACT

The present invention provides a portable device including a processing unit, a biological feature detection module coupled to the processing unit to capture biological feature, a wireless communication module coupled to the processing unit, a temperature sensor coupled to the processing unit to sense temperature of a user, and a biological feature recognition module coupled to the processing unit. When identifying the user, the biological feature detection module and the temperature sensor are activated, wherein the biological features include face, pupil, fingerprint, finger pulse.

### FIELD OF THE INVENTION

The present invention relates to a portable device, and more particularly to a portable device with a thermal sensor.

### BACKGROUND OF THE INVENTION

Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone.

Recently, anti-theft unlocking problems of the portable device are increasingly valued by the market. The traditional password lock applied to the mobile phone can be easily cracked, and therefore the manufacturers develop different anti-theft methods one after another. The gradually mature biological feature recognition technology is highly thought of by the manufacturers and consumers. The common biological feature recognition technology employs a sensor to recognize biological features such as fingerprints, palm prints, shape of face, iris or DNA. The aforementioned methods have their advantages or disadvantages respectively. The fingerprint recognition is the most common one. However, the fingers can leave fingerprints on the surface of the article easily when touching various articles in daily life, such that the fingerprint may be obtained by people with bad intention.

The present invention utilizes and improves the capabilities of the current portable device, so as to provide an invention with utility. The summary and the detailed description of the present invention will be described in detail hereinafter.

### SUMMARY OF THE INVENTION

One object of the present invention is to provide a portable device with face recognition and temperature measuring functions and an authentication method thereof and a transaction system thereof.

The present invention provides a portable device with thermal sensing including: a processing unit; a visible light image sensor coupled to the processing unit to fetch a first image with gradient; a gradient image sensor coupled to the processing unit to fetch a second image; an image generating module coupled to the processing unit to superpose the first image and the second image; and a display coupled to the processing unit to display the superposed image.

In one embodiment, the portable device may include mobile phone, smart phone, digital still camera, digital video camera, media player, tablet PC, personal digital assistant or head mounted device. The portable device may further include a biological feature detection module coupled to the processing unit to capture biological features. The portable device may further include a temperature sensor coupled to the processing unit to sense temperature of a user. The portable device may further include a biological feature recognition module coupled to the processing unit, when performing authentication, the biological feature detection module and the temperature sensor are activated, wherein the biological features include face, pupil, fingerprint or finger pulse. In one embodiment, the authentication includes mobile phone unlock authentication, mobile phone pay authentication or transaction authentication. In one embodiment, the gradient may include temperature gradient or gray scale gradient.

In still another aspect, the present invention provides a portable device with thermal sensing including: a processing unit; a display coupled to the processing unit; a first image capturing module coupled to the processing unit to capture a color image; a wireless communication module coupled to the processing unit; a second image capturing module coupled to the processing unit to capture a gradient image; an image generating module coupled to the processing unit to superpose the color image and the gradient image.

In one embodiment, a thermal image generating module may be employed to generate thermal image. The portable device may further include a bio-security code generator coupled to the processing unit to generate a bio-security code corresponding to a user. In one embodiment, the second image capturing module may obtain a color or gray scale gradient image. The portable device may further include a switching unit to switch between the first image capturing module and the second image capturing module. In one embodiment, the portable device may include mobile phone, smart phone, digital still camera, digital video camera, media player, tablet PC, personal digital assistant or head mounted device.

In one aspect, the present invention provides a mobile phone with thermal sensing including: a processing unit; a display coupled to the processing unit; an image capturing module coupled to the processing unit to capture image signals; a wireless communication module coupled to the processing unit; a sensor coupled to the processing unit to sense temperature signals; an image generating module coupled to the processing unit to superpose the image signals and the temperature signals.

The mobile phone may further include a temperature generating module to generate temperature based on the temperature signals. The mobile phone may further include a biological feature recognition module coupled to the processing unit to recognize biological features, wherein the biological features include face, pupil, fingerprints or finger pulse. In one embodiment, the processing unit may activate the biological feature recognition module and the sensor when performing identity authentication. In one embodiment, the sensor may capture gradient image. In one embodiment, the gradient may include color gradient or gray scale gradient. In one embodiment, the gradient may include temperature gradient.

The present invention will be clearly appreciated from the following description of preferred embodiments taken together with the appended claims.

### BRIEF DESCRIPTION OF THE DRAWINGS

The present invention may be understood by some preferred embodiments and detailed descriptions in the specification and the attached drawings below. However, it should be appreciated that the attached drawings are only for illustrating the present invention, not for limiting the present invention to a specific embodiment.

FIG. 1 is a system diagram of the present invention;

FIG. 2 is a functional diagram of one embodiment of a portable device of the present invention;

FIG. 3 is a functional diagram of a finger pulse detecting module of the portable device of the present invention;

FIG. 4 is a functional diagram of one embodiment of a remote server of the present invention;

FIG. 5 is a functional diagram of another embodiment of a portable device of the present invention; and

FIG. 6 is a functional diagram of an image sensing module of a portable device of the present invention.

### DETAILED DESCRIPTION OF THE PREFERRED EMBODIMENT

The present invention will now be described with the preferred embodiments and aspects and these descriptions interpret structure and procedures of the present invention only for illustrating but not for limiting the Claims of the present invention. Therefore, except the preferred embodiments in the specification, the present invention may also be widely used in other embodiments.

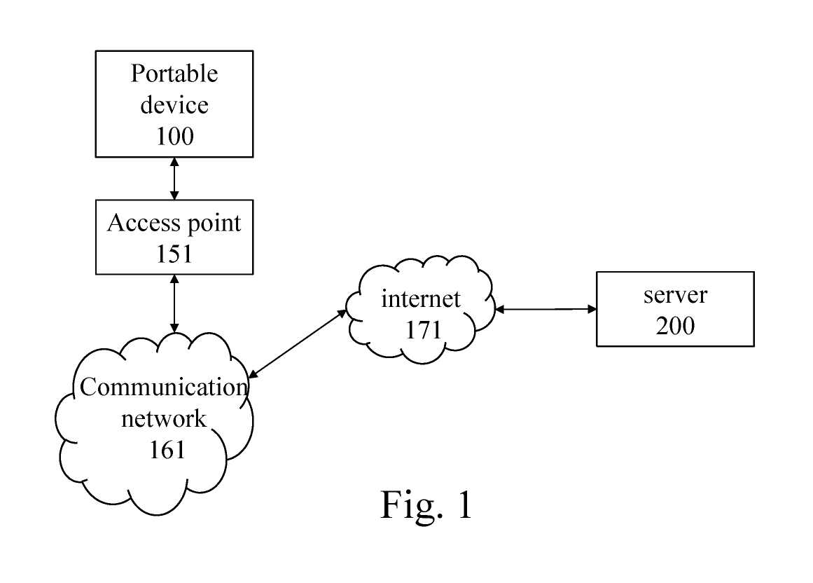

Please refer to FIG. 1, which illustrates a block diagram of a portable device system of one embodiment of the present invention. The basic architecture of the portable device system of this embodiment may include a portable device 100, an access point 151, a communication network (3G/4G/5G) 161, an internet 171 and a server 200. In one example, the portable device 100 includes a finger pulse detecting module, a face recognizing module, a temperature sensor and a mobile pay module, such that the portable device of the present invention can have capabilities of mobile phone unlocking, mobile phone pay authentication, unmanned store authentication or other security recognition functions. For instance, the portable device 100 of the present invention may employ the face recognizing module in cooperation with the temperature sensor to perform the face image recognition and the measurement of body temperature of a user, so as to confirm that the recognized person is the user himself or herself (living person) on site, not a photograph or an image of the user. In other words, in addition to image recognition, the measurement of the user's body temperature is further needed to enter the portable device 100. As an example, the portable device 100 may include mobile phone, smart phone, digital still camera, digital video camera, media player (Mp3, MP4), tablet PC, personal digital assistant, or head mounted device, such as virtual reality (VR) device. The finger pulse detecting module of the portable device 100 of the present invention can generate heart rate (heart beat) recognition pattern of the user, which may be transmitted to a remote server 200 via the access point 151 or further through the communication network 161 and the internet 171.

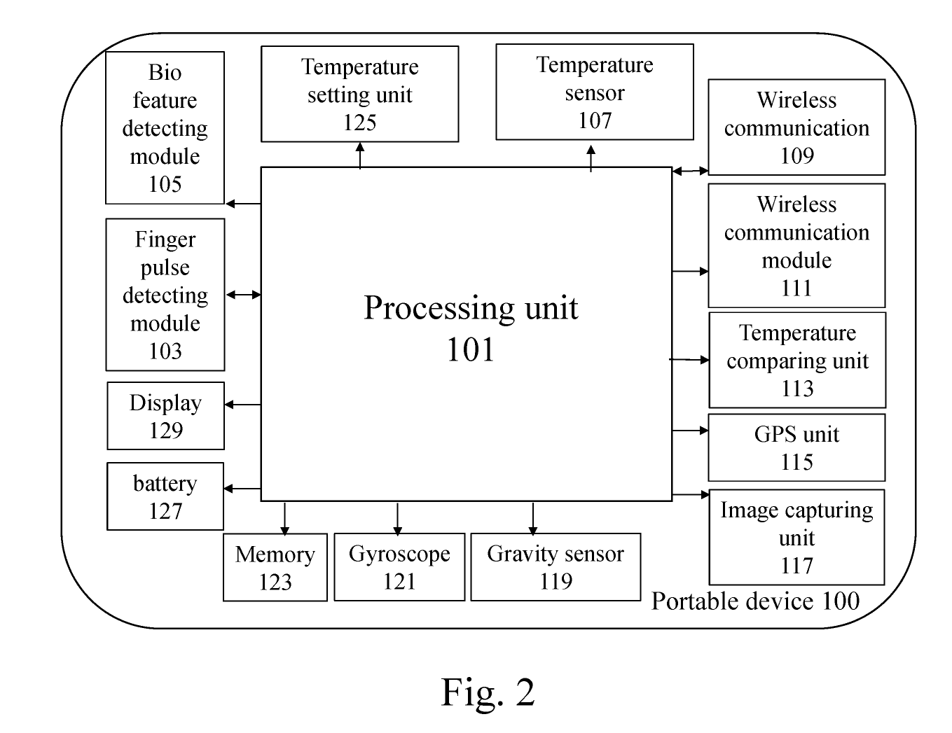

Please refer to FIG. 2, which illustrates a functional block diagram of the portable device 100 of one embodiment of the present invention. In this embodiment, the portable device may include a battery 127, a processing unit (microprocessor) 101, a finger pulse detecting module 103, a biological feature detecting module (bio-security code generator) 105, a temperature sensor 107, a wireless transmission module 109, a wireless communication module 111, a temperature comparing unit 113, a global positioning system (GPS) unit 115, an image capturing unit 117, a gravity sensor 119, a gyroscope 121, a memory 123, a temperature setting unit 125 and a display 129; each of the aforementioned components, modules or units is directly or indirectly coupled to the processing unit 101. The GPS unit 115 is employed to navigate via satellite signals while the gyroscope 121 or the gravity sensor 119 is utilized to determine the motion of the user. The image capturing unit 117 may include a camera module to capture the image taken by the portable device 100. In one embodiment, the portable device 100 further includes an audio outputting unit which includes a speaker. The portable device 100 may include a microphone coupled to the processing unit 101. In the present invention, various biological features such as face images, pupil images, fingerprints, voice, heart rate (heart beat) recognition pattern of the user may be captured through the portable device 100. The heart rate (heart beat) recognition patterns and the captured face images of the user may be wirelessly transmitted to the access point 151 and the heart rate (heart beat) recognition patterns and the captured images may be uploaded to the remote server 200 via the communication network 161 or/and the internet 171 and be stored in the remote server 200. That is to say, the portable device 100 of the present invention may provide the face images and the heart rate (heat beat) recognition patterns of the user to the remote server 200 for example as the mobile phone unlocking, mobile phone pay authentication, transaction authentication of unmanned store. Of course, the biological features mentioned above may be stored in the portable device 100.

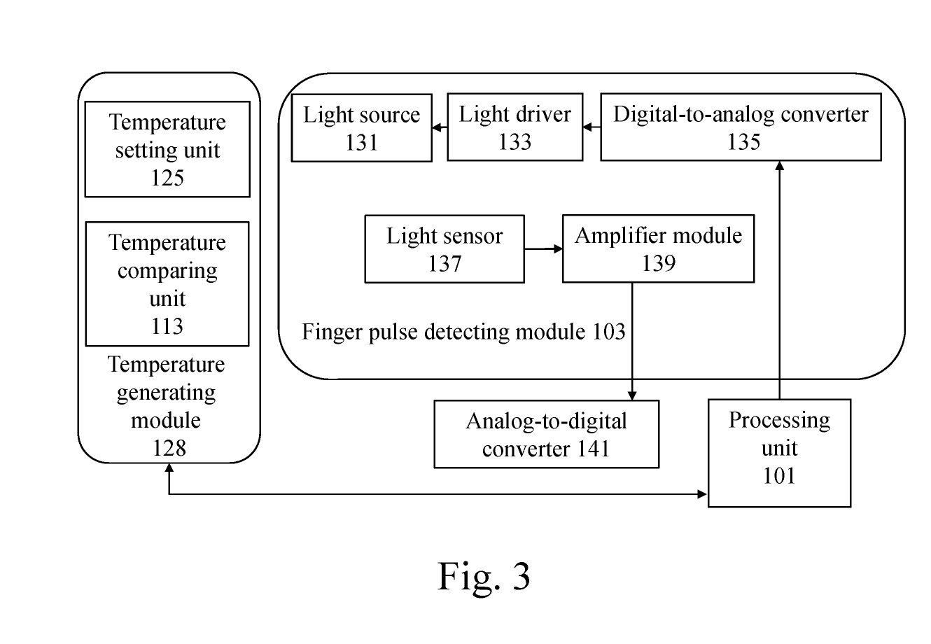

As an example, the finger pulse detecting module 103 may include at least one light source 131, light driver 133, a digital-to-analog converter 135, at least one light sensor 137 and an amplifier module 139, as shown in FIG. 3. The light driver 133 is electrically connected (coupled to) with at least one light source 131 and the digital-to-analog converter 135. At least one light sensor 137 is coupled to the amplifier module 139. The digital-to-analog converter 135 is coupled to the processing unit 101. The amplifier module 139 is coupled to an analog-to-digital converter 141 as shown in FIG. 3. The analog-to-digital converter 141 is coupled to the processing unit 101. For instance, the analog-to-digital converter 141 is configured in the portable device 100. The working principle of the finger pulse detecting module 103 is: employ the light source 131 to emit light (for example red light or infrared light) toward the pulse blood flow recognition area of the user's finger. When the heart beats, the amount of the light reflected by the blood and returning to the light sensor 137 will change. Then, the calculation of the processing unit 101 is employed to analyze the pulse condition of the user. In one instance, the finger pulse detecting module 103 is configured with multiple light sources 131, and the multiple light sources 131 may emit red light and infrared light alternately. The ratio of the red light and the infrared light received by the light sensor 137 can be employed to calculate the percentage of oxygen content in the blood because the oxyhemoglobin in the blood absorbs more infrared light than red light and the deoxygenated hemoglobin absorbs more red light than infrared light. As an instance, the amplifier module 139 may include a filtering amplifier and a programmable gain amplifier. The amplifier module 139 amplifies the signal from the light sensor 139 and transmit it to the analog-to-digital converter 141. The analog-to-digital converter 141 converts the signal and transmits it to the processing unit 101. Therefore, the processing unit 101 may process and analyze the signal sensed by the light sensor 137. In other words, the pulse condition may be obtained via the calculation and the analysis of the processing unit 101. The finger pulse detecting module 103 can record the change signal generated by the fine amount of change of light caused by the blood flow in the blood vessel in detail during the user's systole and diastole and convert the change signal into a waveform diagram or a scatter diagram. The finger pulse detecting module 103 may be employed to finish identifying the identity of the user based on the waveform comparison and recognition because everyone has his/her unique waveform, so as to achieve the security protection effect of the portable device 100.

The wireless communication module 111 includes a RF (radio frequency) module. It should be appreciated by the person having ordinary skill in the art that the RF module includes an antenna. The antenna is connected with a transceiver to receive and transmit signals. It should be appreciated by the person having ordinary skill in the art that the RF module further includes CODEC, digital signal processor (DSP) and analog-to-digital converter.

The portable device 100 may further include a temperature generating module 128 coupled to the processing unit 101 to generate a temperature based on an infrared signal, so as to display the temperature on the display 129. The temperature comparing unit 113 and the temperature setting unit 125 may be integrated into the temperature generating module 128 as shown in FIG. 3.

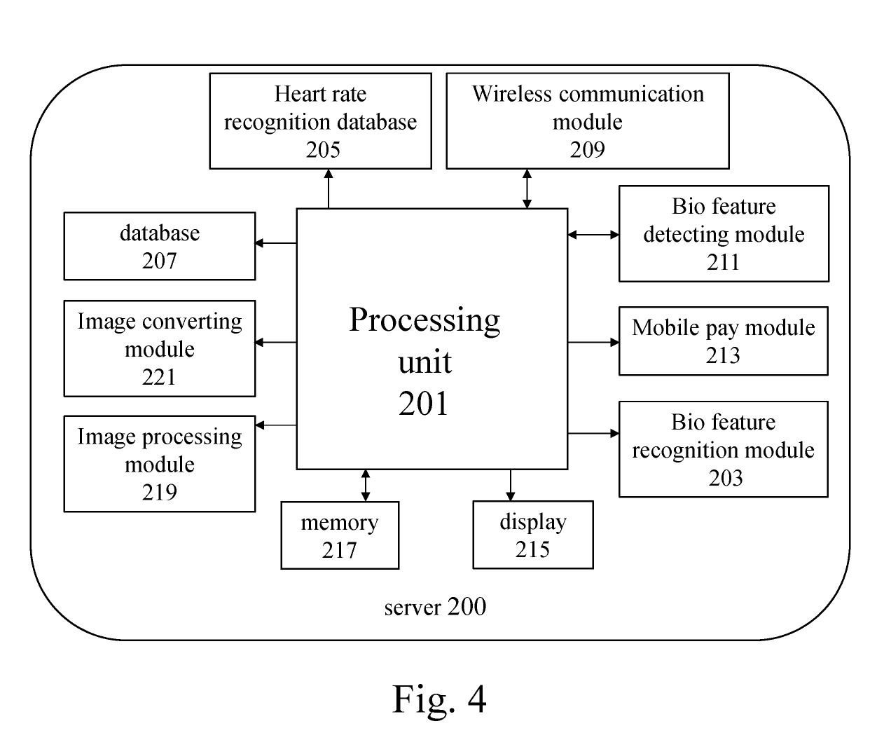

Please further refer to FIG. 4, which illustrates a functional block diagram of a remote server of the present invention. The remote server 200 may include a processing unit 201, a biological feature recognition module (bio-security code recognition module) 203, a heart rate recognition database 205, a database 207, a wireless communication module 209 (for instance selected from wide area communication, local area communication or the combination thereof), a biological feature detecting module (bio-security code generator) 211, a mobile pay module 213, a display 215, a memory 217, an image processing module 219 and an image converting module 221. The biological feature recognition module 203, the heart rate recognition database 205, the database 207, the wireless communication module 209, the biological feature detecting module 211, the mobile pay module 213, the display 215, the memory 217, the image processing module 219 and the image converting module 221 are electrically coupled to the processing unit 201 respectively. The image converting module 221 is employed to process the captured image and change the format thereof. The database 207 is utilized to store the image processed by the image converting module 221. The image or data captured by the portable device 100 may be transmitted to the remote server 200 through the wireless communication module 109 and/or the wireless communication module 111 of the present invention. Of course, the various biological features mentioned above may be stored in the portable device 100.

In one embodiment, the wireless communication connection between the portable device 100 and the remote server 200 may specifically employ the following connection methods: wireless communication technologies or specifications such as wireless communication network (3G/4G/5G), satellite communication network, Wi-Fi, 802.11x (x=a, b, g, n), Bluetooth low energy (BLE), long term evolution (LTE), Zigbee or infrared etc.

The memory 123 and 217 of the present invention may include ROM (read only memory), RAM (random access memory), nonvolatile flash memory, etc. The display 129 includes multi-touch panel such as resistive touch panel or capacitive touch panel, and so on.

As mentioned above, after the wireless communication module 109 (such as wireless communication network (3G/4G/5G) module) is coupled with the access point 151, the access point 151 is further connected with the wireless communication module of the remote server 200 through the communication network 161 or/and internet 171, and then the remote server 200 receives the data such as photographs or images transmitted from the wireless communication module 109. The transaction data of the mobile pay module may also be displayed on the display during the aforementioned transmission process.

As shown in FIG. 2, the portable device 100 includes the biological feature detecting module 105. The present invention employs the biological feature, not the text type code, as the security code of the portable device 100. The biological feature may include face image, pupil image, fingerprints, voice, and so on of the user. The face image, the eye image and the fingerprints of the user may be obtained via the image capturing unit 117 while the voice features may be collected through the microphone. After the template of the biological features are collected, these biological features are stored in the portable device 100 or the remote server 200 and the corresponding bio-security codes are generated via the biological feature detecting module 105. These bio-security codes may be stored in the portable device 100 or the remote server 200. In another embodiment, the server 200 includes the biological feature detecting module 211 to generate the bio-security code for the portable device 100. After the biological features of the user are generated by the image capturing unit 117 or the microphone, the biological features of the user are transmitted to the server 200. The bio-security codes stored in the database 207 are compared with the captured biological feature by the biological feature recognition module 203 for unlock and transaction authentication, such as mobile phone unlocking, mobile phone pay authentication, unmanned store transaction authentication, etc.

For remote authentication or transaction, the GPS (satellite positioning) unit 115 is utilized to acquire a position information corresponding to the portable device 100 to provide the geographical coordinates at which the user is located. The geographical coordinates cooperate with the stored map information to perform navigation or search specific coordinates. Subsequently, after the wireless communication module 111 (such as wireless communication network (3G/4G/5G) module) is coupled with the access point 151, the access point 151 is further connected with the wireless communication module of the server 200 through the communication network 161, internet 171, and then the server 200 receives the image data, the finger pulse waveform signals or the scatter diagram transmitted from the wireless communication module 111. The image data, the finger pulse waveform signals or the scatter diagram transmitted from the wireless communication module 111 are performed with biological feature recognition in the server 200 for the pay transaction authentication of the portable device 100, the transaction authentication of the unmanned store. The biological feature recognition mentioned above may also be implemented at the mobile phone end.

As mentioned above, the portable device 100 of the present invention may include a temperature sensor 107 coupled to the processing unit 101. In one embodiment, the temperature sensor 107 may include an infrared temperature sensor 107 to sense the body temperature of the user with the infrared temperature sensor 107. The temperature sensor 107 may include an active infrared temperature sensor or a passive infrared temperature sensor. The active infrared temperature sensor performs the sensing of the body temperature by actively emitting infrared light and receiving the infrared light reflected by the user while the passive infrared temperature sensor implements the sensing of the body temperature by receiving the infrared light emitted by the user. In one example, the temperature sensing procedures of the portable device 100 include the following steps. Firstly, the temperature setting unit 125 presets the temperature range according to the user's demand. For instance, the user can set the body temperature range to be 36□˜40□ according to his/her body condition. The purpose of the temperature sensor is to cooperate with the face recognition, the fingerprint recognition or the pupil recognition to assist in determining that the face or the biological feature signals are live user signals, not photographs or other digital images. That is to say, when the user activates the biological feature recognition, the processing unit 201 at least activates the biological feature recognition module 203 and the temperature sensor 208 to perform the biological feature recognition and the temperature detection at the same time, so as to ensure the accuracy of the identity recognition. The temperature sensor 107 can sense the body temperature of the user in real time to acquire the body temperature value of the user sensed by the temperature sensor 107. The temperature sensor 107 may be activated by for example general purpose input output (GPIO). The temperature comparing unit 113 determines whether the sensed body temperature value of the user is in the preset body temperature range or not. If yes, the authentication is completed or unlock succeeds. If not, the authentication or unlock fails. For instance, if the temperature comparing unit 113 determines that the obtained body temperature value of the user 37.2□ is in the preset body temperature range (36□˜40□) and the comparison of the recognized biological feature matches, authentication is completed or unlock succeeds.

When the processing unit 101 receives the measured temperature value from the temperature sensor 107, it is determined that whether the measured temperature value is within the possible range of the human body's temperature or not. If not, the functions of unlocking, paying authentication, and the transaction authentication are prohibited. If yes, the biological feature recognition is performed, for example the face image matches the temperate, the authentication will be approved. The temperature sensor 107 is utilized to sense the body temperature of the user. The temperature sensor 107 may be configured in the portable device 100. In one embodiment, the temperature sensor 107 may be configured outside of the portable device 100 to be directly connected with the portable device 100 via a connection wire. However, the mobile phone unlocking, pay authentication, and the transaction authentication of the unmanned store are performed by comparing the feature images of the identical feature of the user (such as face, eye) and sensing the temperature of the user at the same time.

The finger pulse detecting module 103 detects the pulse blood flow signal in the finger's capillary of the user who uses the portable device 100. The analog-to-digital converter 141 converts the pulse blood flow signal of the user, and the characteristic points are captured by the processing unit 101 and are compared with the preset characteristic points of the user in the heart rate recognition database 205 in the server 200 or the mobile phone. If the characteristic points of the user match the preset characteristic points of the user in the heart rate recognition database 205, the correct signals are output and the user is permitted to perform subsequent user authentication and transaction.

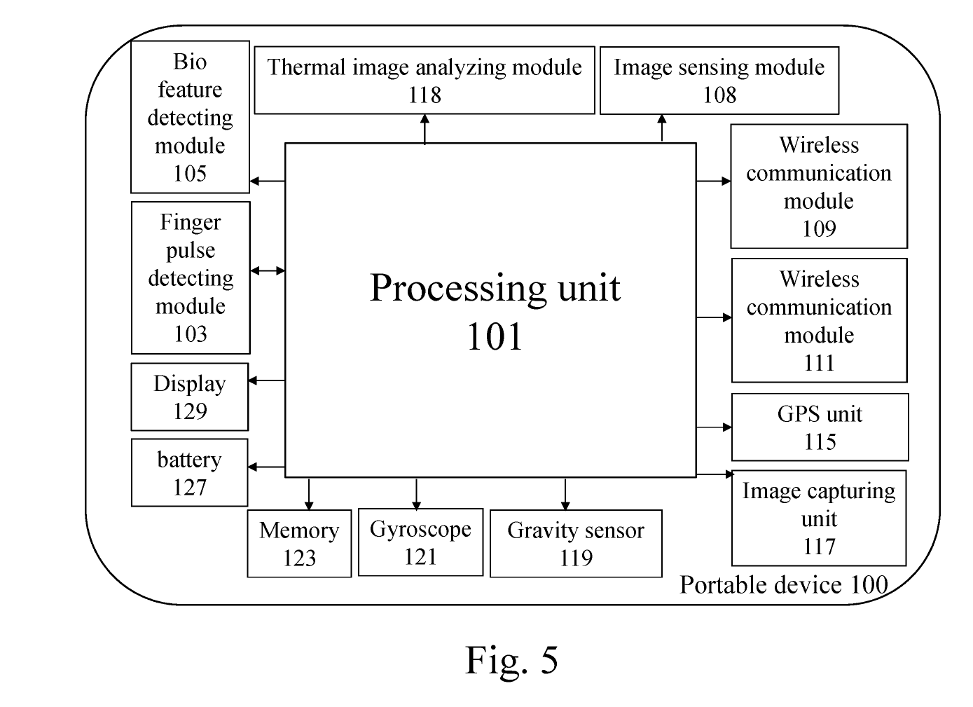

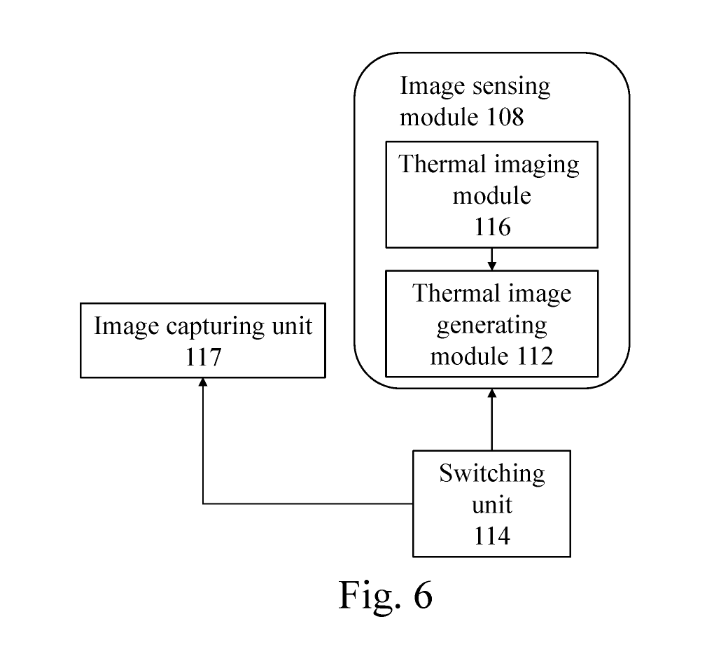

In another embodiment, the portable device 100 includes a gradient image sensing module 108 coupled to the processing unit 101 as shown in FIG. 5. In nature, all objects whose temperature is higher than absolute zero (−273.16 degrees Celsius) emit infrared light continuously. Regardless of the time of day or night, all objects emit infrared light. The gradient image sensing module 108 includes a thermal imaging module 116 which employs an infrared detector to receive the infrared irradiation signal from the object to be detected, utilizes the internal electronic scanning circuit to scan the infrared thermal image of the object under detecting and convert them into the electrical signals, followed by amplifying the electrical signals, converting and outputting the infrared thermal images to the display. The gradient image sensing module 108 may include a thermal image generating module 112 to generate the gradient image of the user. One of the examples is temperature gradient. The image capturing unit 117 is employed to obtain the image of the user and the image capturing unit 117 may be visible light camera, and in one example, the gradient image sensing module 108 has an infrared detector. Therefore, the images acquired by the image capturing unit 117 and the gradient image sensing module 108 are superposed by the image generating module 112. One of the examples is to obtain the thermal color gradient image or gray scale gradient image. Other gradient image can be formed to replace the gradient image sensing module 108. The image capturing unit 117 is employed to obtain the image of the user, and a switching unit 114 is coupled to the image capturing unit 117 and the thermal image generating module 112 to switch between the normal visible light image and the gradient imaging with reference to FIG. 6. That is to say, the switching unit 114 may switch the image sensing module 108 of the portable device 100 into a body temperature sensing mode or a common camera sensing mode. When the switching unit 114 switches into the thermal image generating module 112 (i.e. the body temperature sensing mode), the gradient image sensing module 108 may be utilized to measure the body temperature (or light) gradient of the user to serve as a clinical thermometer and display the temperature in the photographs which may be a normal photograph or a thermal imaging photograph, or display both on the display. When the switching unit 114 switches into the visible light image capturing unit 117 (i.e. the common camera sensing mode), the image sensing module 108 may be employed to obtain the image of the user. As an example, the thermal imaging module 116 may include a thermal sensor while the image capturing unit 117 includes a light sensor. The thermal sensor may display the temperature gradient on the display and it can perform the function of calculating the body temperature of the user.

Taken as an example, the gradient image sensing module 108 may be an infrared light camera module, which may have a pixel resolution of at least about 240 pixels×320 pixels, a thermal accuracy of 2 degrees Celsius or 2%, a thermal sensitivity smaller than about 0.1 degrees Celsius and an operational power requirement of about 25 Watt for the appliance of battery driving. The infrared light camera module may be remotely located with respect to one or more objects to be imaged, and the thermal image from the infrared light camera module may be analyzed by the thermal image analyzing module 118 of the portable device 100. The temperature gradient may then be displayed on the display by the thermal sensor and the body temperature of the use may be calculated by the processing unit 101.

In another embodiment, once the portable device 100 receives the infrared thermal image, the infrared thermal image may be transformed into the temperature data. A mathematical algorithm or formula may be applied to perform the transformation. The mathematical algorithm or formula employs the given emittance value to correlate the sensor data of the infrared light camera module in Watt with thermal value. The infrared thermal images may be processed, calculated and converted into the temperature data by the processing unit 101 of the infrared light camera module. As mentioned above, the pixel values in the infrared thermal images indicate the temperature at physical points in the space. Thus, the average value or the median of the temperature values of these pixels may be determined.

The wireless communication module 109 is compatible to wireless communication protocols and can process the data transmission of the wireless communication protocols. For instance, the wireless communication module 109 may be Bluetooth compatible module, Wi-Fi wireless transmission standard compatible module, 802.11x wireless transmission standard compatible module, or WiMAX (Worldwide Interoperability for Microwave Access) wireless transmission standard compatible module. The portable device 100 of the present invention can wirelessly transmit image signals to the server 200 simultaneously through the wireless communication module 109.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the present invention. It is intended that all such modifications and alterations are included insofar as they come within the scope of the present invention as claimed or the equivalents thereof.

What is claimed is:

1. A portable device with thermal sensing, wherein said portable device includes mobile phone, comprising:
a processing unit;
a gradient image sensor coupled to said processing unit to fetch a first image;
an image generating module coupled to said processing unit to generate a gradient image; and
a display coupled to said processing unit to display said gradient image.

2. The portable device of claim 1, a visible light image sensor coupled to said processing unit to fetch a second image with gradient;

3. The portable device of claim 1, further comprising a biological feature detection module coupled to said processing unit to capture biological features.

4. The portable device of claim 3, further comprising a temperature sensor coupled to said processing unit to sense temperature of a user.

5. The portable device of claim 4, further comprising a biological feature recognition module coupled to said processing unit, when performing authentication, said biological feature detection module and said temperature sensor are activated, wherein said biological features include face, pupil, fingerprint or finger pulse.

6. The portable device of claim 5, wherein said authentication includes mobile phone unlock authentication, mobile phone pay authentication or transaction authentication.

7. The portable device of claim 1, wherein said gradient includes temperature gradient or gray scale gradient.

8. A portable device with thermal sensing comprising:
a processing unit;
a display coupled to said processing unit;
a first image capturing module coupled to said processing unit to capture a color image;
a wireless communication module coupled to said processing unit;
a second image capturing module coupled to said processing unit to capture a gradient image;
an image generating module coupled to said processing unit to generate a gradient image.

9. The portable device of claim 8, wherein a thermal image generating module is employed to generate thermal image.

10. The portable device of claim 8, further comprising a bio-security code generator coupled to said processing unit to generate a bio-security code corresponding to a user.

11. The portable device of claim 8, wherein said second image capturing module obtains a color or gray scale gradient image.

12. The portable device of claim 8, further comprising a switching unit to switch between said first image capturing module and said second image capturing module.

13. The portable device of claim 8, wherein said portable device includes mobile phone, smart phone, digital still camera, digital video camera, media player, tablet PC, personal digital assistant or head mounted device.

14. A mobile phone with thermal sensing comprising:
a processing unit;
a display coupled to said processing unit;
an image capturing module coupled to said processing unit to capture image signals;
a wireless communication module coupled to said processing unit;
a sensor coupled to said processing unit to sense temperature signals;
an image generating module coupled to said processing unit to superpose said image signals and said temperature signals.

15. The portable device of claim 14, further comprising a temperature generating module to generate temperature based on said temperature signals.

16. The portable device of claim 14, further comprising a biological feature recognition module coupled to said processing unit to recognize biological features, wherein said biological features include face, pupil, fingerprints or finger pulse.

17. The portable device of claim 16, wherein said processing unit activates said biological feature recognition module and said sensor when performing identity authentication.

18. The portable device of claim 14, wherein said sensor captures gradient image.

19. The portable device of claim 18, wherein said gradient includes color gradient or gray scale gradient.

20. The portable device of claim 18, wherein said gradient includes temperature gradient.
